(19) United States
(12) Patent Application Publication
(10) Pub. No.: US 2017/0316489 A1
(43) Pub. Date: Nov. 2, 2017

(54) APPARATUSES AND METHODS FOR RECIPE SUGGESTION

(71) Applicant: Wal-Mart Stores, Inc., Bentonville, AR (US)

(72) Inventors: Henry Sampara, Bentonville, AR (US); Michael D. Atchley, Springdale, AR (US); Donald R. High, Noel, MO (US)

(21) Appl. No.: 15/499,644

(22) Filed: Apr. 27, 2017

Related U.S. Application Data
(60) Provisional application No. 62/328,745, filed on Apr. 28, 2016.

(51) Int. Cl. G06Q 30/06; G06Q 10/08

(52) U.S. Cl. CPC G06Q 30/0633; G06Q 10/087; G06Q 30/0631

(57) ABSTRACT

Systems, apparatuses, and methods are provided herein for providing recipe suggestions. In one embodiment, a system for recipe suggestion comprises a customer inventory information database, a recipe database, a communication device configured to communicate with a user device; and a control circuit coupled to the customer inventory information database, the recipe database, and the communication device The control circuit is configured to collect and update customer inventory information stored in the customer inventory information database, select one or more recommended recipes from the recipe database to recommend to a customer based on at least a customer inventory information associated with the customer, and for each recommended recipe comprising one or more missing ingredients not in a customer inventory according to the customer inventory information database: cause the user device to display a purchase suggestion of the one or more missing ingredients to the customer.

### CROSS-REFERENCE TO RELATED APPLICATION

This application claims the benefit of the following U.S. Provisional Application No. 62/328,745 filed Apr. 28, 2016, which is incorporated herein by reference in its entirety.

### TECHNICAL FIELD

This invention relates generally to recommendation services.

### BACKGROUND

A recipe typically includes a set of instructions and a list of the ingredients for preparing a particular dish. A home cook wanting to make a recipe typically has to remember the content of their pantry and go to a store to purchase additional ingredients necessary to make the recipe.

### BRIEF DESCRIPTION OF THE DRAWINGS

Disclosed herein are embodiments of apparatuses and methods for recipe suggestion. This description includes drawings, wherein:

FIG. 1 is a block diagram of a system in accordance with several embodiments.

FIG. 2 is a flow diagram of a method in accordance with several embodiments.

FIG. 3 is a process diagram of a general process in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for recipe suggestion. In some embodiments, a system for recipe suggestion comprises a customer inventory information database, a recipe database, a communication device configured to communicate with a user device; and a control circuit coupled to the customer inventory information database, the recipe database, and the communication device The control circuit is configured to collect and update customer inventory information stored in the customer inventory information database, select one or more recommended recipes from the recipe database to recommend to a customer based on at least a customer inventory information associated with the customer, and for each recommended recipe comprising one or more missing ingredients not in a customer inventory according to the customer inventory information database: cause the user device to display a purchase suggestion of the one or more missing ingredients to the customer.

When purchasing ingredients for family meals, shoppers often do not remember what items are already in their refrigerator or cabinet and end up wasting food by purchasing duplicates of items. Families also typically do not have a good method of tracking recipe preferences of family members.

In some embodiments, a recipe maker service provides recipe recommendations based on a number of servings required, what products customers have available in their pantry, and the family's preferences. Conventional recipes are typically written for a set portion. Customer making a recipe often end up with leftovers or need to attempt to keep a mental record of recipe variations to prepare a meal.

In some embodiments, as items are purchased, a system may keep an estimated customer inventory using e-receipt, on-line order record, and/or mobile app order record. Paper receipts may also be scanned to add to the customer inventory information. As recipes are used by customers, item counts in the estimated customer inventory may be reduced according to the quantities called for in the recipe. In some embodiments, the reduction of inventory items may be verified by a smart refrigerator with scales and/or smart sensors on cabinets to reduce the need for manual entry. In some embodiments, when an item is purchased, the item may be first marked as “purchased” based on an e-receipt or a scanned paper receipt in the customer inventory data. The system may obtain the e-receipt, on-line order, or mobile app order directly from the store database at the time of purchase. In some embodiments, a user may enter a paper receipt into the system by scanning the paper receipt with their smart device or personal scanner. The system may also capture dates of purchase, expiration dates, and other associated information from the receipts.

In some embodiments, when a user put purchased items away in their smart refrigerator or on shelves with smart sensors, the inventory status of an item may change from a “purchased” status to a “shelved” status. As products are removed from the smart refrigerator or shelves, the inventory items may be marked as “in-use” with anticipation of a quantity reduction.

In some embodiments, the system may recommend recipes based on customer inventory information. In addition to recommending recipes, the system may also obtain information regarding where customer items are stored on the shelves when smart refrigerators or shelves are used. When a recipe is made by a customer, the inventory reduction associated with the recipe and may be verified with the smart refrigerator and/or smart shelf scales. In some embodiments, the system may allow users to override the reduction amounts associated with a recipe based on their preferred recipe modifications.

In some embodiments, users may set their personal preferences, favorite recipes, alterations to recipes, alterations to portion sizes, allergies, and dietary constraints in the system. The system may then use the customer preference information to make recipe recommendations.

In some embodiments, replenishment of items may be recommended based on a combination of inventory levels, prior usage, and any future recipes a customer has selected. For example, if the user /customer wishes to have a party or a special program at a future date, the system may recommend adjustments of inventory levels to accommodate the planned event. In some embodiments, the system may take in a scheduled party program and uses predictive analytics to preorder items and adjust inventory to accommodate the expected increase in ingredient usage. Other replenishment orders may be generated based on predictive behavior and customer approval. In some embodiments, products may be delivered when a customer's favorite product runs low without the customer having to manually place an order for the product.

In some embodiment, the system may automatically aggregate customer inventory information based on e-receipts, on-line or mobile purchases, and/or scans of paper receipts. In some embodiments, item information may be transferred from a purchase system to a customer inventory system to record purchase date, expiration date, and location of purchase in case of return. In some embodiments, the system may maintain a central repository of favorite recipes. The system may also offer access to other recipes via data capture capabilities of search engine web crawler technology. In some embodiments, the system may build recipes using on-line services. In some embodiments, the system may automatically perform reduction of estimated customer inventory based on a customer's recipe use. The reduction of an item may be validated by a smart refrigerator or other in-home sensors. In some embodiments, the system may perform predictive replenishment based on data collected by a smart refrigerator and/or smart sensors on cabinets. In some embodiments, the system may further carry out proactive replenishment for on planned future parties, programs, or family get-together dinners. In some embodiments, the system allows for multiple family members to rate recipes/meals based on their personal preferences.

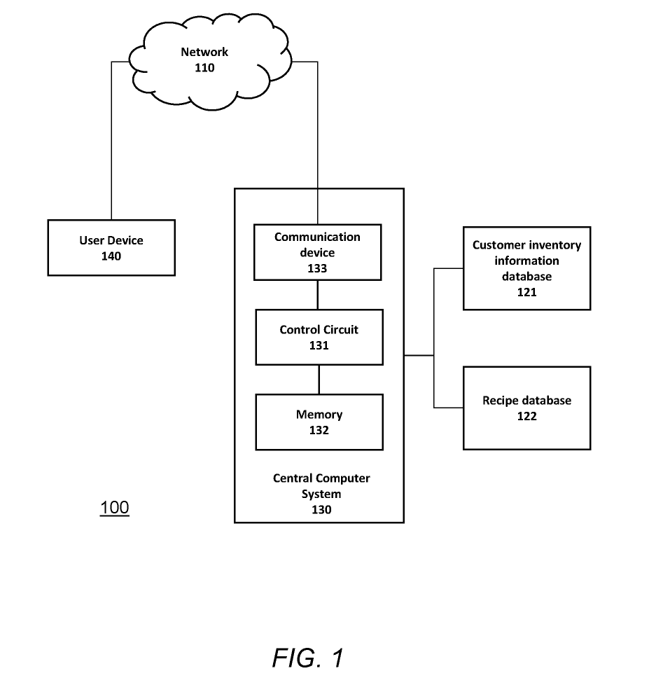

Referring now to FIG. 1, a system for providing recipe suggestions is shown. The system 100 comprises a central computer system 130 coupled to a customer inventory information database 121 and a recipe database 122. The central computer system 130 is further configure to communicate with user devices 140 over a network 110.

The central computer system 130 comprises a control circuit 131, a memory 132, and a communication device 133 and may generally be any processor-based device such as one or more of a computer system, a server, a networked computer, a cloud-based server, etc. The control circuit 131 may comprise a central processing unit, a processor, a microprocessor, and the like. The control circuit 131 may be configured to execute computer readable instructions stored on the memory 132. The memory 132 may comprise volatile and/or non-volatile computer readable storage memory and have stored upon it a set of computer readable instructions which, when executed by the control circuit 131, causes the system to recommend recipes and items for purchase using the information stored in the recipe database 122 and the customer inventory information database 121. The communication device 133 may comprise a communication interface that allows the control circuit 131 to communicate with a plurality of user devices 140 via a network 110. In some embodiments, the communication device 133 may comprise one or more wired or wireless network adapters, modems, routers, etc. The network 110 may comprise any communication channel configured to allow multiple remote devices to communicate with each other. In some embodiments, the network 110 may comprise the Internet.

The customer inventory information database 121 may comprise a computer readable storage medium storing information relating to items in customers' inventories. A customer inventory may generally refer to items that are accessible and/or in the possession of a customer, which may be located at one or more customer premises. The customer inventory information database 121 may store estimated inventories of a plurality of customers. In some embodiments, the estimated customer inventories may include a list of item types and item quantities. In some embodiments, the customer inventory information database 121 may store additional information relating to the items in the customer inventory such as item purchase date, expiration date, purchase price, etc. In some embodiments, the central computer system 130 and/or another network accessible system may aggregate customer inventory information to build and update the information in the customer inventory information database 121. In some embodiments, a system may obtain customer purchase information from point of sale (POS) terminals such as in-store purchase terminals and online stores. Items and quantities of items purchased through POSs may be automatically added to the estimated customer inventory for the purchasing customer. In some embodiments, the system may provide a user interface via a user device 140 for a customer to enter customer inventory information. In some embodiments, a user may take pictures of purchase receipts and the system may extract information regarding purchased items from the images of receipts. In some embodiments, a user may take pictures of their inventory storage area (e.g. refrigerator, cupboard, pantry, shelf, etc.) and upload the pictures to the system via the provided user interface and the system may perform image recognition to identify items in the customer's inventory. In some embodiments, the user device 140 may comprise a Radio Frequency Identification (RFID) scanner and the user device 140 may scan for item RFID tags in the vicinity of the user device 140 to provide customer inventory information. In some embodiments, a user may use the user device 140 to scan barcodes on items in his/her inventory to update the customer inventory information in the customer inventory information database 121. In some embodiments, a user interface may be provided for the user to manually enter and modify the inventory information associated with the user.

In some embodiments, the system may obtain customer inventory information from sensors at the customer's premises. For example, a smart refrigerator and/or storage spaces with smart sensors may monitor the contents of the storage spaces and communicate the detect items to the system to update the customer inventory information database 121. In some embodiments, the customer inventory information may be automatically updated based on customer's selected recipes and/or meals. For example, if a customer selects to use a recipe that calls for three eggs and two onions, the system may decrement the estimated eggs and onions inventory in the customer inventory information by the amount specified in the recipe. In some embodiments, a customer may specify the serving size of the recipe that is prepared (e.g. half of a serving, 2 servings, etc.) and the estimated inventory may be reduced according to the serving size prepared by the customer. In some embodiments, the system may record expiration dates of items in the customer inventory and may automatically remove items known to be expired from the estimated inventory of the customer. In some embodiments, the system may be configured to send a notification to the customer when an item is close to expiring and/or expired. In some embodiments, the customer inventory information stored in the database may be collected and updated using a combination of two or more methods described herein.

The recipe database 122 may comprise a plurality of recipes each comprising a list of ingredients. In some embodiments, the central computer system 130 or another system may be configured to aggregate a plurality of recipes from various sources such as customers, crowd sourced contributions, scanned publications, and web pages. In some embodiments, the recipes may further specify a required quantity of ingredients per serving portion (e.g. 2 teaspoons, 3 counts, 5 oz., etc.). In some embodiments, the recipe database 122 may further store a list of substitutable ingredients (e.g. vinegar and milk as a substitute for buttermilk).

In some embodiments, the central computer system 130 may further be coupled to a customer profile database (not shown). The customer preference database may store a plurality of customer profiles comprising information such as one or more of: customer demographic, family size, dietary restrictions, dietary preferences, favorite recipes, favorite ingredients, recipe selection histories, planned recipes, planned events, purchase histories, etc. The central computer system 130 may select one or more recipes from the recipe database 122 and/or make purchase recommendations based on the information in the customer inventory information database 121 and/or the customer profile.

The user device 140 may comprise any processor-based device having a processor, a memory device, and one or more user input/output devices. In some embodiments, the user device 140 may comprise one or more of a personal computer, a desktop computer, a laptop computer, a tablet computer, a smartphone, a wearable device, etc. In some embodiments, the central computer system 130 may provide a network accessible user interface such as a mobile application (“app”), a web site, an app widget, and the like on the user device 140. The user device 140 may generally be configured to display recipe recommendations and/or purchase recommendations generated by the central computer system 130. In some embodiments, when a recipe is recommended to a customer, the user may select the portion size (e.g. 3 servings, 5 servings, etc.) in the user interface, and the system may be configured to modify the qualities ingredients on the recommended recipes based on the selected portion size. In some embodiments, the user interface may further provide a purchase interface for the user to select and order ingredients of a recipe directly from the user interface. In some embodiments, a customer may use the user device 140 to view, add, and/or update customer profile information and/or customer inventory information stored in the customer inventory information database 121. In some embodiments, the user device 140 may further include a sensor for scanning product information from products in the customer's inventory. For example, the user device may include one or more of an optical sensor, an RFID scanner, a barcode scanner, etc. A customer may use the user interface provided on the user device 140 to capture an image of their storage space, scan a receipt, scan an item identifier, etc. to update their customer inventory information. In some embodiments, the provided user interface may comprise an interface for the user to manually enter customer inventory information by typing in item name, item descriptions, item Universal Product Code (UPC), etc.

While the customer inventory information database 121 and the recipe database 122 are shown to be outside of the central computer system 130 in FIG. 1, in some embodiments, the customer inventory information database 121, the recipe database 122, the customer profile database, and/or the memory 132 may be implemented on the same one or more computer readable memory devices.

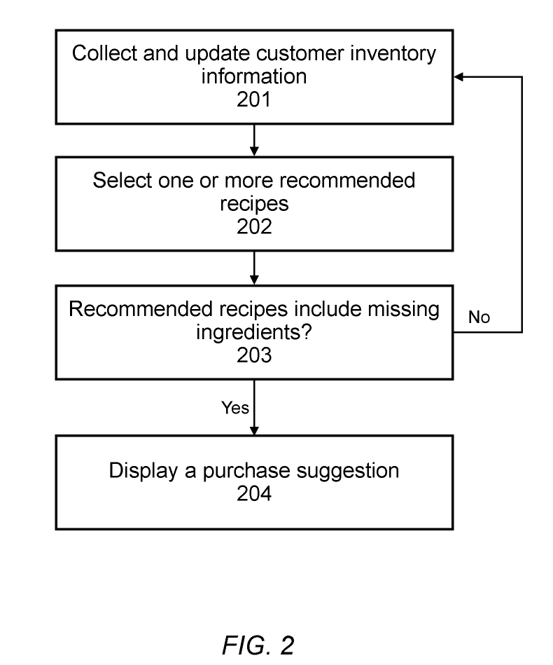

Referring now to FIG. 2, a method of providing recipe suggestions according to some embodiments is shown. Generally, the method shown in FIG. 2 may be implemented with a processor-based device such as a control circuit, a central processor, and the like. In some embodiments, the method shown in FIG. 2 may be implemented with the central computer system 130 and/or a control circuit of the user device 140 in FIG. 1.

In step 201, the system collects and updates customer inventory information. In some embodiments, the customer inventory information may be updated based on customer purchases recorded at one or more of an in-store register and an online store purchase system. Items and quantities of items purchased may be automatically added to the estimated customer inventory for the associated customer. In some embodiments, the system may provide a user interface via a user device for the user to enter customer inventory information. In some embodiments, the customer inventory information may be updated based on customer entered information comprising one or more of: an item identifier, an item image, an image of a customer food storage area, and an image of a purchase receipt. In some embodiments, a user may take pictures of purchase receipts and the system may extract information regarding purchased items from the images of the receipts. In some embodiments, a user may take pictures of a customer inventory storage area (e.g. refrigerator, cupboard, pantry, shelf, etc.) and upload the pictures to the system via the provided user interface. The system may then perform image recognition to determine the items in the customer's inventory. In some embodiments, a user device may comprise an RFID scanner, and the user device may scan for item RFID tags in the vicinity of the user device to provide customer inventory information to the system. In some embodiments, a user may use a user device to scan barcodes on items in his/her inventory to update the inventory information. In some embodiments, a user interface may be provided for the user to manually enter and/or modify the inventory information associated with the user.

In some embodiments, the customer inventory information may be updated based on sensor data collected by a network-connected appliance at a customer premises. For example, a smart refrigerator and/or storage spaces with smart sensors may monitor for the content of its storage space and communicate the detected items to the central system to update the customer inventory information. In some embodiments, the customer inventory information may be automatically updated based on customer's selected recipes and/or meals. For example, if a customer selects a recipe to prepare that calls for three eggs and two onions, the system may decrement the estimated eggs and onions inventory in the customer inventory by the amount specified in the recipe. In some embodiments, a customer may specify the portion size of the recipe that is prepared (e.g. half of a serving, 2 servings, etc.) and the estimated inventory may be reduced according to the portion size prepared by the customer.

In some embodiments, the customer inventory information database updated by the system may store estimated inventories of a plurality of customers each including a list of item types and item quantities. In some embodiments, the customer inventory information database may store additional information relating to the items in the customer inventory such as purchase date, expiration date, purchase price, etc. In some embodiments, the system may automatically remove items known to be expired from the estimated inventory of the customer. In some embodiments, the system may be configured to send a notification to the customer when an item is close to expiring and/or expired. In some embodiments, the customer inventory information stored in the database may be collected and updated using a combination of two or more methods described herein.

In step 202, the system selects recommended recipes for a customer. In some embodiments, one or more recommended recipes may be selected from a recipe database to recommend to a customer based on at least a customer inventory information associated with the customer. In some embodiments, the recipe database may comprise recipes aggregated from various sources such as customers, crowd sourced contributions, scanned publications, and web pages. In some embodiments, one or more recipes may specify a required quantity of ingredients per serving size (e.g. 2 teaspoons, 3 counts, 5 oz., etc.). In some embodiments, the recipe database may further store a list of substitutable ingredients (e.g. vinegar and milk as a substitute for buttermilk). The substitutable ingredients may be specific to one or more recipes and/or may be applicable to all recipes. In some embodiments, the system may recommend a recipe to a customer even if one or more ingredients in the recipe are missing from the customer's inventory. In some embodiments, the system may set a threshold of a number of missing ingredients that a recommended recipe could include (e.g. 1, 2, or 3). In some embodiments, recommending a recipe to the customer comprises causing the recipe to be displayed on a user interface of a user device.

In some embodiments, the recommended recipes are selected based on maximizing the number of recipes that can be prepared by the customer while limiting the number of missing ingredients to a predetermined number. For example, the system may determine that with the purchase of one additional ingredient (e.g. dried pepper), the customer can add five additional recipes that can be prepared with their current inventory. The system may then recommended the purchase of the missing ingredient(s) along with one or more recipes that may be compared with the customer's current inventory and the addition of the missing ingredient(s). In some embodiments, the user interface may show a list of recommended ingredients to purchase. When a user selects a recommended ingredient, the system may display a list of new recipes that may be prepared with the additional of the selected ingredient.

In some embodiments, the recommended recipes are selected and/or prioritized based on an expiration date of one or more items in the customer inventory. For example, if a bottle of milk is near expiration in the customer's inventory, the system may suggest a recipe that makes use of the bottle of milk before the expiration date. In some embodiments, such recipes may be prioritized among the list of recommended recipes and/or an expiration alert may be displayed along with the recommendation. In some embodiments, the one or more recommended recipes may further comprise a recommended prepare date determined based on an expiration date of the one or more items in the customer inventory.

In some embodiments, the system stores the cost/pricing information for one or more ingredients used in the recipes. The cost information may be associated with the customer's actual purchase prices and/or may correspond to a current and/or average price of the ingredient. The system may calculate a total estimated cost for one or more recipes based on the cost and the quantity of the ingredients in the recipe. In some embodiments, the one or more recommended recipes may be further selected and/or prioritized based on an estimated total cost of ingredients in the recipe. For example, the system may show a cost rating for one or more recommended recipes and/or allow users to filter and/or sort recipes based on the estimated total cost.

In some embodiments, the recommended recipes may be selected and/or prioritized based on customer profile information such as customer demographic, family size, dietary restrictions, dietary preferences, favorite recipes, favorite ingredients, used recipes, planned recipes, planned events, purchase histories, etc. In some embodiments, the system may rate a plurality of recipes based considerations relating to customer's inventory information and/or customer profile, and select and/or prioritize the recipes to recommend to the customer according to the rating. In some embodiments, the customer profile may comprise profile information associated with multiple family members in a customer household that typically share meals. The system may take each family member's preferences into account in the selection of recipes to recommend.

In step 203, the system determines whether each recommended recipe comprises one or more missing ingredients not in a customer inventory according to the customer inventory information database. In some embodiments, the system may first determine whether the missing ingredients may be substituted with other ingredients in the customer inventory. If a substitute ingredient is available, the system may recommend the substitution for the missing ingredient in the recipe. In some embodiments, the system may first prompt the user to enter a planned portion size (e.g. for 2, for 4, etc.) for the recipe. The system may compare the quantity of the ingredients required for the selected portion size and the customer inventory information to determine whether sufficient qualities of each ingredient is present in the customer inventory. In some embodiments, an ingredient with insufficient quantities may be considered a missing ingredient. In some embodiments, if the recommended and/or user selected recipe(s) contains no missing ingredients, the process may return to step 201.

If one or more ingredients are missing in the recommended and/or user selected recipes in step 204, the system may cause the user device to display a purchase suggestion of the one or more missing ingredients to the customer. In some embodiments, the system may provide a user interface for displaying the purchase suggestion on the user device, and the user interface may comprise an item ordering function for ordering the one or more missing ingredients in the recipes. For example, a user may select an ingredient displayed in a recipe to add the ingredient to a shopping cart for online purchase and/or to a shopping list for in-store purchase. In some embodiments, the purchase suggestion may further comprise a quantity suggestion for the one or more missing ingredients. In some embodiments, the quantity suggestion may be determined based on one or more of: the one or more recommended recipes, a purchase history of the customer, an item usage history of the customer, and one or more recipes of planned future meals of the customer. In some embodiments, the quantity suggestion further comprises a packaging type suggestion determine based on the relative costs of different packaging types. For example, if a customer typically uses up 3 lbs of flour every six months, the system may recommend the purchase of a 3 lbs bag of flour at a lower price, instead of recommending three lb bags of flour at a higher total price. In some embodiments, when a user selects an ingredients list to add to a shopping cart and/or shopping list, the item may be added according to the suggested quantity by default. In some embodiments, the system may allow a user to indicate that an ingredient assumed to be missing by the system is actually present in the customer's inventory. In some embodiments, the system may prompt the customer to enter the quantity of the ingredient assumed to be missing from customer's inventory.

In some embodiments, recommendations and customer selections in various steps of FIG. 2 may be recorded in the customer's profile as preferences and usage history. The ingredient usage history recorded by the system may be used to estimate a depletion rate for various ingredients. In some embodiments, after step 204, information on items purchased by the customer through the user interface may be recorded to update the customer inventory information. In some embodiments, a user may select a recipe from the recommended recipes to use, and the system may then adjust the customer inventory information based on the ingredients in the selected recipe. For example, if a recipe calling for 3 eggs is used, the estimated number of eggs in the customer inventory may be reduced by three. In some embodiments, the user may add one or more recipes to a planned meal for a future date. The system may then determine whether sufficient quantities of ingredients will be available at the future date and recommend items to purchase and/or replenish based on the planned future meal. For example, if the user indicates that he/she is preparing a meal for a large gathering in a week, even if sufficient ingredients are currently present in the customer inventory, the system may monitor the customer inventory and suggest the purchase of additional items if one or more ingredients needed for the gathering is likely to run low or run out by the event date. In some embodiments, the system may estimate the customer inventory at a plurality of future dates based on the ingredients in one or more planned meals. The system may then recommend purchases and/or generate an automatic order to help customers maintain a sufficient inventory for the one or more planned future meals.

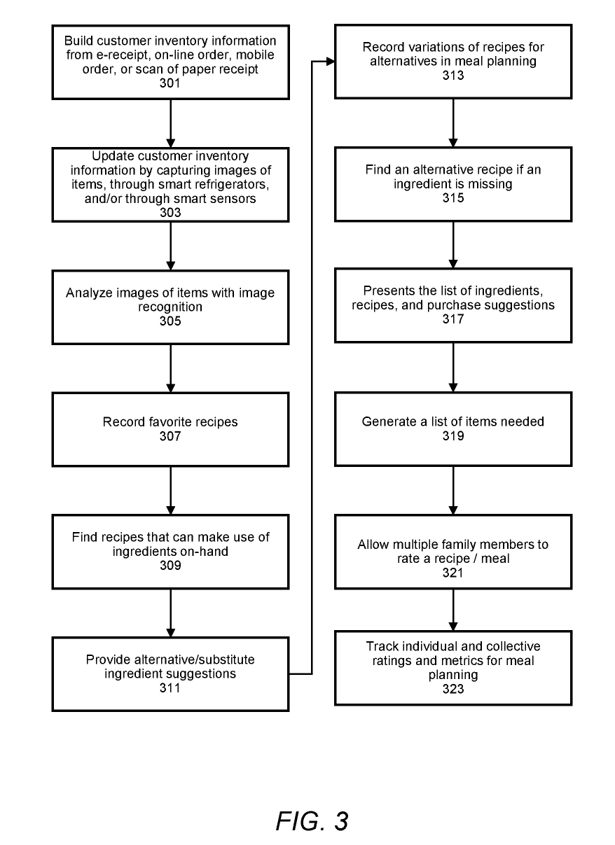

Now referring to FIG. 3, a process for recommending recipes according to some embodiments is shown. In step 301, the system builds customer inventory information. The information may be gathered from one or more of e-receipts, on-line orders, mobile orders, and/or scans of paper receipts. In step 303, the system updates customer inventory information by capturing images of items in the customer's inventory, through smart refrigerators, and/or through smart sensors. Generally, cameras and sensors may be used to provide information on items in customer's storage spaces such as refrigerators, freezers, cabinets, pantries, etc. In step 305, images of customer storage spaces are analyzed with image recognition algorithms. For example, the system may look at barcodes, logos, texts, and shapes in the images of items to determine an item's type and/or size. Item identified in the images may be used to update the customer's estimated inventory information. In some embodiments, the system may ignore objects that are not recognized through image recognition.

In step 307, the system records a customer's favorite recipes. In some embodiments, the recipes may be selected and/or entered by a customer (e.g. mom's dumplings, Aunt Susie's cream cheese cherry pie, pioneer woman's broiled chops, etc.). In some embodiments, the recipes may comprise past recipes used and/or rated by the customer. The favorite recipes may form an electronic cookbook for the customer. In step 309, the system finds recipes that can make use of the ingredients the customer has on-hand. For example, a customer may seek a recipe to use up 2 pounds of ground beef and 20 ounces of sour cream. In step 311, the system optionally provides alternative/substitute ingredients to the customer to complete a recipe (e.g. use milk and vinegar as a substitute for buttermilk, or substitute whole tomatoes with crushed tomatoes, canned tomatoes, etc.).

In step 313, the system records variations of recipes for alternatives in meal planning. For example, the system may store a number of recipe variations for making chili. In step 315, the system finds an alternative recipe if an ingredient in a preferred recipe is missing. For example, a customer may wish to make chili but do not have all the ingredients to make their favorite chili recipe. The system may then suggest an alternative chili recipe based on the ingredients available to the customer.

In step 317, the system presents the list of ingredients and recipes to the user. The user may decide if they wish to accept the recipe and/or purchase more items to complete recipes. In step 318, the system may generate a list of items needed to complete one or more selected recipes. The generated list may be used to purchase items online or in-store.

In step 321, the system may provide a user interface for multiple family members to rate a recipe and/or meal. Family members may individually rate recipes and/or meals depending on their taste and dietary preference. In step 323, the system tracks individual and collective ratings and metric for recipes. The ratings may then be used for further meal planning. For example, recipes may be selected and/or prioritized in the recommendation based on family member's past ratings of recipes.

In one embodiment, a system for recipe suggestion comprises a customer inventory information database, a recipe database, a communication device configured to communicate with a user device; and a control circuit coupled to the customer inventory information database, the recipe database, and the communication device The control circuit is configured to collect and update customer inventory information stored in the customer inventory information database, select one or more recommended recipes from the recipe database to recommend to a customer based on at least a customer inventory information associated with the customer, and for each recommended recipe comprising one or more missing ingredients not in a customer inventory according to the customer inventory information database: cause the user device to display a purchase suggestion of the one or more missing ingredients to the customer.

In one embodiment, a method for recipe suggestion comprises collecting and updating by a control circuit, customer inventory information in a customer inventory information database, selecting, by the control circuit, one or more recommended recipes from a recipe database to recommend to a customer based on at least a customer inventory information associated with the customer stored in the customer inventory information database, and for each recommended recipe comprising one or more missing ingredients not in a customer inventory according to customer inventory information database: causing, via a communication device coupled to the control circuit, a user device to display a purchase suggestion of the one or more missing ingredients to the customer.

In one embodiment, an apparatus for recipe suggestion comprises a non-transitory storage medium storing a set of computer readable instructions and a control circuit configured to execute the set of computer readable instructions which causes to the control circuit to: collect and update customer inventory information stored in a customer inventory information database, select one or more recommended recipes from a recipe database to recommend to a customer based on at least a customer inventory information associated with the customer stored in the customer inventory information database; and for each recommended recipe comprising one or more missing ingredients not in a customer inventory according to customer inventory information database: cause, via a communication device coupled to the control circuit, a user device to display a purchase suggestion of the one or more missing ingredients to the customer.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for recipe suggestion comprising:
a customer inventory information database;
a recipe database;
a communication device configured to communicate with a user device; and
a control circuit coupled to the customer inventory information database, the recipe database, and the communication device, wherein the control circuit is configured to:
collect and update customer inventory information stored in the customer inventory information database;
select one or more recommended recipes from the recipe database to recommend to a customer based on at least a customer inventory information associated with the customer; and
for each recommended recipe comprising one or more missing ingredients not in a customer inventory according to the customer inventory information database: cause the user device to display a purchase suggestion of the one or more missing ingredients to the customer.

2. The system of claim 1, wherein the one or more of recommended recipes are selected based on maximizing a number of recipes that can be prepared by the customer while limiting a number of missing ingredients to a predetermined number.

3. The system of claim 1, wherein the one or more of recommended recipes are further selected and/or prioritized based on an expiration date of one or more items in the customer inventory.

4. The system of claim 1, wherein the one or more recommended recipes further comprises a recommended prepare date determined based on an expiration date of one or more items in the customer inventory.

5. The system of claim 1, wherein the one or more recommended recipes are further selected and/or prioritized based on an estimated total cost of ingredients in the recipe.

6. The system of claim 1, wherein the customer inventory information is updated based on customer purchases recorded at one or more of an in-store register and an online store purchase system.

7. The system of claim 1, wherein the customer inventory information is updated based on sensor data collected by a network connected appliance at a customer premises.

8. The system of claim 1, wherein the customer inventory information is updated based on customer entered information comprising one or more of: an item identifier, an item image, an image of a customer food storage area, and an image of a purchase receipt.

9. The system of claim 1, wherein the control circuit is further configured to provide a user interface for displaying the purchase suggestion on the user device, and the user interface comprises an item ordering function for ordering the one or more missing ingredients.

10. The system of claim 1, wherein the purchase suggestion further comprises a quantity suggestion for the one or more missing ingredients.

11. The system of claim 10, wherein the quantity suggestion is determined based on one or more of: the one or more recommended recipes, a purchase history of the customer, an item usage history of the customer, and one or more recipes of planned future meals of the customer.

12. The system of claim 10, wherein the quantity suggestion further comprises a packaging type suggestion determine based on a relative cost of different packaging types.

13. A method for recipe suggestion comprising:
collecting and updating, by a control circuit, customer inventory information in a customer inventory information database;
selecting, by the control circuit, one or more recommended recipes from a recipe database to recommend to a customer based on at least a customer inventory information associated with the customer stored in the customer inventory information database; and
for each recommended recipe comprising one or more missing ingredients not in a customer inventory according to the customer inventory information database: causing, via a communication device coupled to the control circuit, a user device to display a purchase suggestion of the one or more missing ingredients to the customer.

14. The method of claim 13, wherein the one or more recommended recipes are selected based on maximizing a number of recipes that can be prepared by the customer while limiting a number of missing ingredients to a predetermined number.

15. The method of claim 13, wherein the one or more recommended recipes are further selected and/or prioritized based on an expiration date of one or more items in the customer inventory.

16. The method of claim 13, wherein the one or more recommended recipes further comprises a recommended prepare date determined based on an expiration date of one or more items in the customer inventory.

17. The method of claim 13, wherein the one or more recommended recipes are further selected and/or prioritized based on an estimated total cost of ingredients in the recipe.

18. The method of claim 13, wherein the customer inventory information is updated based on customer purchases recorded at one or more of an in-store register and an online store purchase system.

19. The method of claim 13, further comprising: providing a user interface for displaying the purchase suggestion on the user device, wherein the user interface comprises an item ordering function for ordering the one or more missing ingredients.

20. The method of claim 13, wherein the purchase suggestion further comprises a quantity suggestion for the one or more missing ingredients.

21. The method of claim 20, wherein the quantity suggestion is determined based on one or more of: the one or more recommended recipes, a purchase history of the customer, an item usage history of the customer, and one or more recipes of planned future meals of the customer.

22. The method of claim 20, wherein the quantity suggestion further comprises a packaging type suggestion determine based on a relative cost of different packaging types.

23. An apparatus for recipe suggestion comprising:
a non-transitory storage medium storing a set of computer readable instructions; and
a control circuit configured to execute the set of computer readable instructions which causes to the control circuit to:
collect and update customer inventory information stored in a customer inventory information database;
select one or more recommended recipes from a recipe database to recommend to a customer based on at least a customer inventory information associated with the customer stored in the customer inventory information database; and
for each recommended recipe comprising one or more missing ingredients not in a customer inventory according to the customer inventory information database: cause, via a communication device coupled to the control circuit, a user device to display a purchase suggestion of the one or more missing ingredients to the customer.
